(19) United States
(12) Patent Application Publication
(10) Pub. No.: US 2026/0131196 A1
(43) Pub. Date: May 14, 2026

(54) PELVIC FLOOR MUSCLE REPAIR DEVICE

(71) Applicant: Shenzhen S-Hande Technology Co., Ltd., SHENZHEN (CN)

(72) Inventor: Jing HE, SHENZHEN (CN)

(21) Appl. No.: 18/958,065

(22) Filed: Nov. 25, 2024

(30) Foreign Application Priority Data
Nov. 8, 2024 (CN) 202422731832.2

(51) Int. Cl. A63B 23/20; A61H 9/00; A61H 21/00; A61H 23/02; A63B 21/00; A63B 21/068

(52) U.S. Cl. CPC A63B 23/20; A61H 9/0057; A61H 21/00; A61H 23/0254; A63B 21/068; A63B 21/4039

(57) ABSTRACT

The present disclosure relates to the field of medical and healthcare instruments, specifically relates to an pelvic floor muscle repair device that includes a body and a variable diameter structure sleeved around the body, wherein the body is a strip-shaped structure, and the variable diameter structure is connected to the body and configured to change a diameter of the body. The present disclosure can choose bodies with different diameters according to a user's situation, and gradually reduce an overall diameter of the body as a repair process progresses to better suit the user, and also can reduce production costs and be convenient storage.

### BACKGROUND

### 1. Technical Field

The present disclosure generally relates to the field of medical and healthcare instruments, and especially relates to a pelvic floor muscle repair device.

### 2. Description of Related Art

Pelvic floor muscles refer to a muscle group that seals the pelvic floor, which are like a hanging net for tightly suspending organs such as a urethra, a bladder, a vagina, a uterus and a rectum, etc., so as to maintain multiple physiological functions such as a micturition and a defecation. During a pregnancy and childbirth process, normal individuals inevitably cause varying degrees of damage to the pelvic floor muscles, leading to pelvic floor muscle dysfunction. This can cause organs to be unable to maintain their normal positions, resulting in the pelvic floor organs prolapse or urinary and fecal incontinence. As women age, infections, inflammations or injuries can cause pelvic floor muscles relaxation. Mild discomforts such as lower abdominal distension, frequent urination and constipation can occur in mild cases, while severe cases can lead to urinary incontinence, uterine prolapse, bladder prolapse, rectal prolapse and other diseases, thereby causing indescribable pains and affecting a life quality, a normal life and physical and mental health of women.

Faced with injuries of the pelvic floor muscles, many people choose to perform a pelvic floor repair on the pelvic floor muscle. A pelvic floor repair rod is usually used to perform the pelvic floor muscle repair, but a conventional pelvic floor repair rod is automatically adjustable and structurally complex, resulting in a high price and inability to be widely used. During in the pelvic floor muscle repair process, as a repair time progresses, the pelvic floor muscles and vaginal relaxation can be changed, which requires to change a size of a repair head of the pelvic floor repair rod. However, the size of the repair head of the conventional pelvic floor repair rod is fixed, so that it can only adapt to different degrees of muscle relaxation by replacing the pelvic floor repair rod, which undoubtedly increases costs again.

Therefore, a new pelvic floor muscle repair device should be designed to solve the above problems.

### SUMMARY

The technical problems to be solved: in view of the shortcomings of the related art, the present disclosure provides a pelvic floor muscle repair device which can solve problems of the related art.

The technical solution adopted for solving technical problems of the present disclosure is:
a pelvic floor muscle repair device according to an embodiment of the present disclosure includes a body and a variable diameter structure sleeved around the body, wherein the body is a strip-shaped structure, and the variable diameter structure is connected to the body and configured to change a diameter of the body.

Wherein the variable diameter structure includes a plurality of reduction sleeves sequentially sleeved, and the reduction sleeve that is close to a front end of the body nested on the body.

Wherein a limit ring is arranged at a rear end of the body and configured to be gripped by users.

Wherein each of the body and the plurality of reduction sleeves is made of a soft elastic material.

Wherein the pelvic floor muscle repair device further includes a counterweight block received in the body.

Wherein a stop ring is arranged on a side of each of the plurality of reduction sleeves that is close to the rear end of the body.

Wherein the front end of the body is arc-shaped.

Wherein the pelvic floor muscle repair device further includes a vibration rod received in the body.

Wherein the pelvic floor muscle repair device further includes a sucker received in the rear end of the body.

The present disclosure provides the advantages as below.

Firstly, when the device of the present disclosure is used for performing pelvic floor muscle repair on the pelvic floor muscle, the reduction sleeve can be selected to remove or put on according to a loss of the pelvic floor muscle, so that an overall diameter of the body is within an appropriate range; at the same time, during a rehabilitation process of a user, the plurality of reduction sleeves can be removed sequentially to suit different degrees of repairs. The present disclosure can choose the bodies with different diameters according to a user's situation, and gradually reduce the overall diameter of the body as the repair process progresses to better suit the user. Therefore, it does not need to use the bodies with different diameters separately during a usage process, which can not only reduce production costs, but also allow the plurality of reduction sleeves to be sequentially sleeved around the body according to their diameters of the bodies during storage, thereby making the body as a whole to be convenient storage.

Secondly, due to the setting of the counterweight block, the body is in a vertical state when the device is used by the user. Therefore, the counterweight block can be used to add a corresponding weight training during the pelvic floor muscle rehabilitation process, which can better repair the pelvic floor muscle and shorten a repair cycle thereof.

Thirdly, because the front end of the body needs to be inserted into a human body of the user during the pelvic floor muscle repair process, while the user performs an anal sphincter movement to repair the pelvic floor muscle, in this way, the stop ring is provided for preventing the reduction sleeve from falling off the body and then entering the human body when the body is pulled out of the human body, which is more conveniently to be used.

### BRIEF DESCRIPTION OF THE DRAWINGS

In order to more clearly understand the technical solution hereinafter in embodiments of the present disclosure, a brief description to the drawings used in detailed description of embodiments hereinafter is provided thereof. Obviously, the drawings described below are some embodiments of the present disclosure, for one of ordinary skill in the related art, other drawings can be obtained according to the drawings below on the premise of no creative work.

FIG. 1 is a schematic view of a pelvic floor muscle repair device in accordance with an embodiment of the present disclosure.

FIG. 2 is an exploded, schematic view of the pelvic floor muscle repair device of FIG. 1.

FIG. 3 is a schematic view of a balance weight within a body of the pelvic floor muscle repair device of FIG. 1.

FIG. 4 is a usage schematic view of the pelvic floor muscle repair device of FIG. 1.

FIG. 5 is an exploded, schematic view of a vibrating spear within the body of the pelvic floor muscle repair device of FIG. 1.

The element labels according to the embodiment of the present disclosure shown as below:
1 body, 11 front end, 12 rear end, 2 variable diameter structure, 21 reduction sleeve, 3 limit ring, 4 counterweight block, 5 stop ring, 6 vibration rod, 7 sucker.

### DETAILED DESCRIPTION

Reference will now be made in detail to embodiments, examples of which are illustrated in the accompanying drawings. In the following detailed description, numerous specific details are set forth in order to provide a thorough understanding of the subject matter presented herein. Obviously, the implementation embodiment in the description is a part of the present disclosure implementation examples, rather than the implementation of all embodiments, examples. According to the described exemplary embodiment of the present disclosure, all other embodiments obtained by one of ordinary skill in the related art on the premise of no creative work are within the protection scope of the present disclosure.

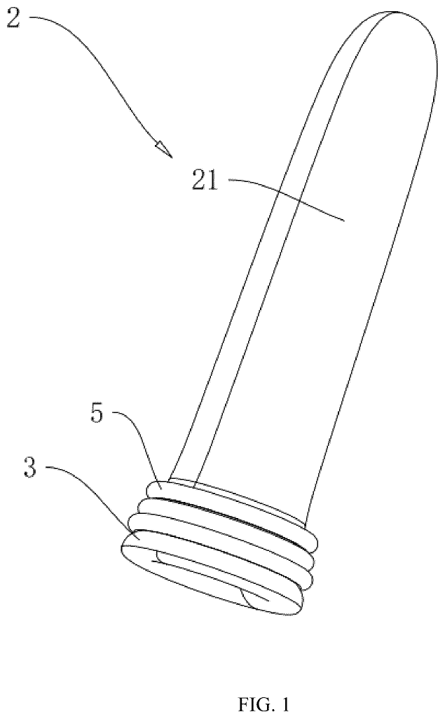

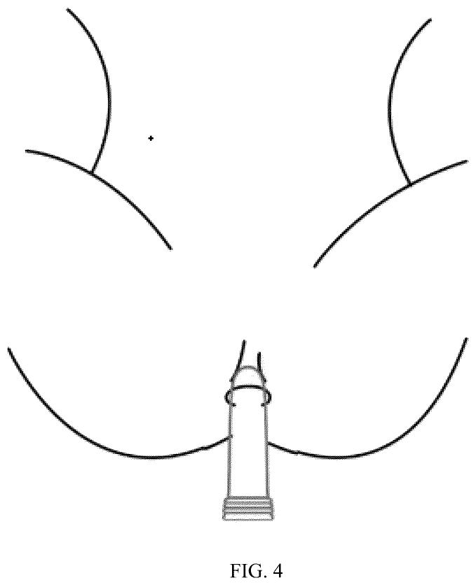

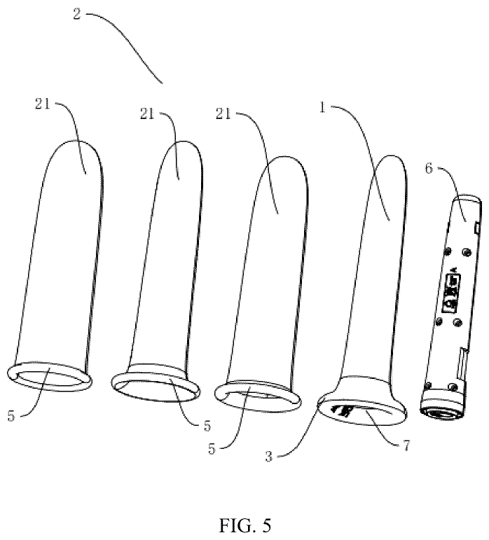

Referring to FIG. 1 to FIG. 5, a pelvic floor muscle repair device in accordance with an embodiment of the present disclosure includes a body 1 and a variable diameter structure 2. Specifically, the body 1 is a strip-shaped structure as a whole, and a front end 11 of the body 1 is configured to be inserted into a user's body. The variable diameter structure 2 is provided on the body 1, so that a diameter of the front end 11 of the body 1 can be changed through the variable diameter structure 2. Therefore, when the user uses the pelvic floor muscle repair device, the diameter of the body 1 can be continuously changed through the variable diameter structure 2 according to a degree of rehabilitation, so that the body 1 is always compatible with the human body. Such way only requires a whole body to complete the entire pelvic floor muscle repair process, rather than needing to use a plurality of bodies with different diameters for performing the pelvic floor muscle repair, which not only reduces production costs and material waste, but also facilitates storage and carrying, at the same time, it can be adapted to different populations according to damages of the pelvic floor muscle.

In an embodiment of the present disclosure, the front end 11 of the body 1 is arc-shaped, so that so when using the body 1, it can be avoided as much as possible to avoid scratching the human body caused by the body 1.

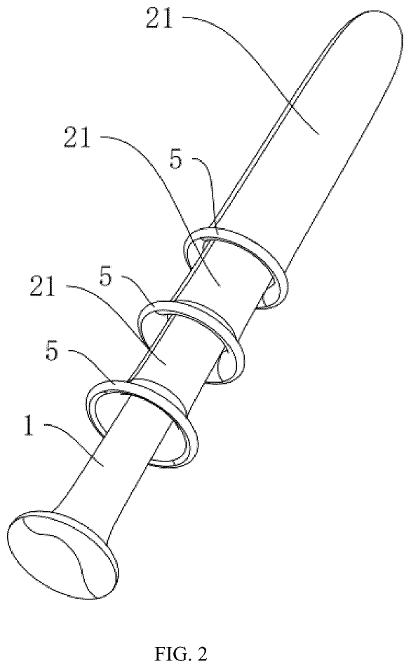

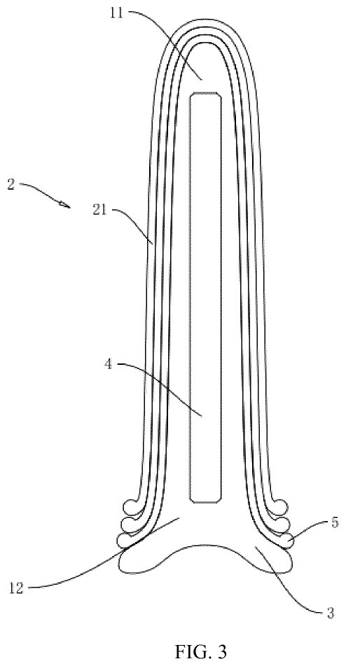

Referring to FIG. 2 and FIG. 3, the variable diameter structure includes a plurality of reduction sleeves 21 sequentially sleeved in turn. Each of the plurality of reduction sleeves 21 includes a cylindrical portion and a hemispherical arc-shaped portion. The arc-shaped portion of the reduction sleeve 21 is configured to seal an opening that is arranged on a side of the cylindrical portion, so that the reduction sleeve 21 completely covers the front end 11 of the body 1. The plurality of reduction sleeves 21 is proportionally reduced and sequentially sleeved on the body 1. By changing the number of reduction sleeves 21 that are placed on the body 1, an overall diameter of the body 1 can be altered. Therefore, when the device is used, the plurality of reduction sleeves 21 can be gradually removed from the body 1 according to the user's rehabilitation condition, as the rehabilitation progresses, gradually reducing the diameter of the body 1 for always adapting to the user, which is convenient for being used. At the same time, when the device needs to be accepted, the plurality of reduction sleeves 21 can be sequentially sleeved on the body 1, so that the body 1 can be stored as a whole, which is convenient for users to carry on and can reduce costs of packaging, production and transportation of the device.

Referring to FIG. 2 and FIG. 3, in order to prevent the body 1 from entirely entering the human's body during using the repair device, a limit ring 3 is provided to install on a rear end 12 of the body 1. The limit ring 3 is integrated with the body 1 and a side of the limit ring 3 is flush with the body 1. When the body 1 is inserted into the human's body, the limit ring 3 will be outside the human's body to prevent the body 1 from entirely entering the human's body, so as to limit a position of the body 1 that is inserted into the human's body. At the same time, the limit ring 3 can facilitate the user to put the body 1 into the human's body or take out the body 1 out of the human's body.

In addition, a sucker 7 is installed at the rear end 12 of the body 1, which is integrally connected to the body 1. When using the pelvic floor muscle repair device, the sucker 7 can be connected to an external structure, so that there is no need to hold the pelvic floor muscle repair device all the time during using the pelvic floor muscle repair device, which is convenient for users to use the pelvic floor muscle repair device.

Referring to FIG. 2 and FIG. 3, at the same time, a stop ring 5 is installed on a side of the reduction sleeve 21 that is close to the rear end 12 of the body 1. The stop ring 5 is integrally connected to the reduction sleeve 21, and is arranged at an opening edge of the reduction sleeve 21. An outer diameter of the stop ring 5 is larger than that of the reduction sleeve 21. When using the repair device, the stop ring 5 is outside the human's body, and when removing the body 1 and the reduction sleeve 21 from the human's body, it can avoid leaving the reduction sleeve 21 inside the human's body.

In the embodiment of the present disclosure, all the body 1, the limit ring 3, the reduction sleeve 21 and the stop ring 5 are made of soft elastic materials. In the embodiment of the present disclosure, the soft elastic material is medical silicone material, which has good elasticity and helps to repair muscle elasticity.

Referring to FIG. 2 and FIG. 3, in order to improve a repair effect of the repair device, a counterweight block 4 is installed on the body 1. The counterweight block 4 is a solid metal block and is arranged inside the body 1. Due to the setting of the counterweight block 4, the body 1 has a certain weight. During using the repair device, the body 1 is in a vertical state. Through a gravity of the counterweight block 4, a corresponding weight training can be added to the pelvic floor muscle rehabilitation process to improve the repair of the pelvic floor muscle and shorten a repair cycle thereof.

In another embodiment of the present disclosure, referring to FIGS. 1 to 5, a vibration rod 6 can also be installed inside the body 1. When using the repair device, the vibration rod 6 generates vibration to promote blood circulation of the pelvic floor muscles during repairing the pelvic floor muscles, while also relaxing the pelvic floor muscles, improving the effectiveness of repairing the pelvic floor muscles and shortening the repair cycle thereof. The counterweight block 4 can be arranged on the vibration rod 6.

Meanwhile, referring to FIGS. 1 to 5, the pelvic floor muscle repair device of the present disclosure can also be applied in the technical field of anus dilators. Firstly, the body 1 is inserted into a user's anus, and according to an expansion size of the anus, different numbers of reduction sleeves 21 are sequentially sleeved on the body 1 to achieve gradual expansion of the anus.

An implementation principle of the pelvic floor muscle repair device of the present disclosure is as follows: when using the pelvic floor muscle repair device to repair the pelvic floor muscles, the plurality of reduction sleeves 21 are removed or fitted according to damages to the user's pelvic floor muscles, so that the overall body 1 is compatible with the user. Moreover, according to the user's repair progress, the plurality of reduction sleeves 21 can be continuously removed until only the body 1 is left. At this point, the pelvic floor muscle repair process is completed. After the pelvic floor muscle repair device is completely used, the plurality of reduction sleeves 21 can be sequentially placed and stored to save materials and facilitate storage.

Although the features and elements of the present disclosure are described as embodiments in particular combinations, each feature or element can be used alone or in other various combinations within the principles of the present disclosure to the full extent indicated by the broad general meaning of the terms in which the appended claims are expressed. Any variation or replacement made by one of ordinary skill in the related art without departing from the spirit of the present disclosure shall fall within the protection scope of the present disclosure.

What is claimed is:

1. A pelvic floor muscle repair device comprising a body and a variable diameter structure sleeved around the body, wherein the body is a strip-shaped structure, and the variable diameter structure is connected to the body and configured to change a diameter of the body.

2. The pelvic floor muscle repair device as claimed in claim 1, wherein the variable diameter structure comprises a plurality of reduction sleeves sequentially sleeved, and the reduction sleeve that is close to a front end of the body nested on the body.

3. The pelvic floor muscle repair device as claimed in claim 1, wherein a limit ring is arranged at a rear end of the body and configured to be gripped by users.

4. The pelvic floor muscle repair device as claimed in claim 2, wherein each of the body and the plurality of reduction sleeves is made of a soft elastic material.

5. The pelvic floor muscle repair device as claimed in claim 1, wherein the pelvic floor muscle repair device further comprises a counterweight block received in the body.

6. The pelvic floor muscle repair device as claimed in claim 3, wherein a stop ring is arranged on a side of each of the plurality of reduction sleeves that is close to the rear end of the body.

7. The pelvic floor muscle repair device as claimed in claim 1, wherein the front end of the body is arc-shaped.

8. The pelvic floor muscle repair device as claimed in claim 1, wherein the pelvic floor muscle repair device further comprises a vibration rod received in the body.

9. The pelvic floor muscle repair device as claimed in claim 1, wherein the pelvic floor muscle repair device further comprises a sucker received in a rear end of the body.
